(19) United States
(12) Patent Application Publication
(10) Pub. No.: US 2013/0302485 A1
(43) Pub. Date: Nov. 14, 2013

(54) COMPOSITIONS AND METHODS FOR REDUCING MERCURY IN FOOD

(71) Applicants: John William Ejnik, Whitewater, WI (US); Daniel F. Neumann, Hartland, WI (US); Ned Thornton, Janesville, WI (US)

(72) Inventors: John William Ejnik, Whitewater, WI (US); Daniel F. Neumann, Hartland, WI (US); Ned Thornton, Janesville, WI (US)

(21) Appl. No.: 13/892,066

(22) Filed: May 10, 2013

Related U.S. Application Data
(60) Provisional application No. 61/645,571, filed on May 10, 2012.

(51) Int. Cl. A23L 1/015

(52) U.S. Cl. CPC A23L 1/0156
USPC 426/271; 426/531

(57) ABSTRACT

The present invention provides compositions and methods for reducing the amount of mercury contaminant in food articles such as fish.

### CROSS-REFERENCE TO RELATED APPLICATIONS

This application claims the priority benefit of U.S. Provisional Application No. 61/645,571, filed May 10, 2012, which is incorporated herein by reference in its entirety.

### FIELD OF THE INVENTION

The present invention relates to compositions and methods for reducing the amount of mercury contaminant in food articles such as fish.

### BACKGROUND OF THE INVENTION

Mercury causes a variety of neurological problems in mammals including learning disabilities in infants and children. Mercury pollutant is passed from pregnant mothers to unborn children. The most common source of mercury pollutant in mammal is from consumption of food, in particular fish. Thus, it is ironic that while most doctors recommend consumption of more fish in western diet to increase intake of omega-3 and omega-6 fatty acids, fish is also the major source of toxic mercury pollutant.

Increased intake of omega-3 and omega-6 fatty acids is particularly important in prenatal babies and infants for neurological developments such as higher brain functions and sight. In fact, doctors often recommend to pregnant mothers to increase intake of omega-3 and omega-6 fatty acids by eating more fish or by taking nutritional supplements containing such fatty acids.

Without being bound by any theory, it is believed that coal power generation generates mercury pollutant in air that ends up in water and is ultimately consumed by fish. Since large fish consume smaller fish, the amount of mercury pollutant is higher in larger fish such as salmon, walleyes, sword fish, tuna, etc. Since coal power generation will continue for the foreseeable future, it is expected that the amount of mercury pollutant in fish is expected to continue to increase.

Currently, most people tend to reduce the intake of mercury pollutant by simply reducing the amount of fish consumption. Unfortunately, simply reducing the amount of fish consumption is not an option for many people whose major staple of food is fish. Therefore, there is a need for a method for efficiently removing mercury pollutant in fish.

### SUMMARY OF THE INVENTION

Some aspects of the present invention provide methods and compositions for removing mercury contaminant from a food source, such as meat, fish, plants, etc. In some embodiments, an aqueous solution is provided for removing mercury contaminant from a food source. Such aqueous solution typically includes a consumable acid, a consumable mercury chelating agent, and a saline concentration that ranges from about 0.15% by weight to about 1% by weight salinity.

As used herein, the term “consumable” means edible or suitable for human consumption at a given amount. Typically, the consumable acid can be an organic acid, inorganic acid, or a combination thereof.

In one particular embodiment, the organic acid is selected from the group consisting of oxalic acid, malic acid, citric acid, acetic acid, glutamic acid, ascorbic acid, formic acid, lactic acid, and a combination thereof. Typically, the organic acid is selected from the group consisting of citric acid, oxalic acid, and a combination thereof.

Yet in other embodiments, the consumable mercury chelating agent comprises acetyl cysteine, taurine, methylsulfonylmethane (MSM), methionine, acetyl methionine, thiosulfate, or a combination thereof. Typically, the consumable mercury chelating agent is selected from the group consisting of acetyl cysteine, methylsulfonylmethane, acetyl methionine, and a combination thereof.

Still in other embodiments, the consumable mercury chelating agent comprises and/or is derived from a food source. Suitable food sources for mercury chelating agent include garlic, onion, nuts, seeds, watermelon, cilantro, broccoli, cabbages, spinach, pineapple, papaya, coconut, mustard, watercress, asparagus, parsley, or a combination thereof.

In other embodiments, the salinity (e.g., sodium chloride) concentration of the aqueous solution ranges from about 0.15% by weight to about 0.5% by weight. Yet in other embodiments, the salinity concentration of the aqueous solution ranges from about 0.25% by weight to about 1.0% by weight. It should be appreciated, however, that the scope of the invention is not limited to these particular salinity level. In general, the scope of the invention includes all range of sodium chloride and other electrolytes (e.g., magnesium, potassium, calcium, etc.) as long as the osmotic pressure of the aqueous solution is less than that of the osmotic pressure of cytosol of food article cells. Without being bound by any theory, it is believed that the hypotonic nature of the aqueous solution—compared to the food article—facilitates removal of mercury from the food article.

Typically, the pH of the initial aqueous solution ranges from about pH 1 to about pH 13, and often from about pH 1 to about pH 7.

The amount of consumable mercury chelating agent in the aqueous solution typically ranges from about 0.005% wt/wt to about 0.5% wt/wt.

Other aspects of the invention provide a method for removing mercury from an unprepared food article or food source. Such a method typically comprises (a) contacting the unprepared (i.e., uncooked or raw) food article with an aqueous solution comprising a consumable acid and a consumable mercury chelating agent under conditions sufficient to remove at least 20% of mercury from the unprepared food article comprising mercury contaminant to produce a purified food article; and (b) separating the purified food article. As used herein, the term “purified food article” refers to a food article that has been subjected to a mercury removal process of the invention. The salinity of the initial aqueous solution used to remove mercury from unprepared food article typically ranges from about 25% to about 75% of the salinity of the unprepared food article itself. That is, the aqueous solution is typically hypotonic relative to the salinity level in the cells of the unprepared food article.

In some embodiments, the method of invention includes subjecting the unprepared food article in the aqueous solution to a reduced pressure condition. In such embodiments, the unprepared food article in the aqueous solution is typically subjected to pressure of about 20 kPa or less, and often 15 kPa or less.

In one particular embodiment, the unprepared food article is fish.

Yet other aspects of the invention provide a method for reducing the amount of mercury from a mercury contaminated food article comprising (a) contacting the mercury contaminated food article with an aqueous solution comprising a consumable acid and a consumable mercury chelating agent under conditions sufficient to provide a purified food article having about 1 ppm of mercury or less per gram of purified food article; and (b) separating the purified food article.

In some embodiments, the mercury contaminated food article is a fillet of fish or cleaned whole fish. It should be appreciated that methods of the invention are typically applied to uncooked or raw food articles. Without being bound by any theory, it is believed that once the food article has been subjected to heat (e.g., cooked), the change in protein structure renders removal of mercury more difficult. Accordingly, typical process for removing mercury is carried out on uncooked or unprepared food article.

Still other aspects of the invention provide a method for preparing a meal comprising a fish fillet. Such a method typically includes contacting an unprepared fish fillet with an aqueous solution comprising a consumable organic acid and a consumable mercury chelating agent under conditions sufficient to reduce the amount of mercury within the unprepared fish fillet if mercury contaminant is present in the unprepared fish fillet; separating the treated fish fillet from the aqueous solution; and preparing a meal using the treated fish fillet. The salinity of the aqueous solution used to treat the fish fillet typically ranges from about 25% to about 75% of the salinity of the unprepared fish fillet.

In some embodiments, the step of contacting the unprepared fish fillet with the aqueous solution comprises subjecting the mixture to a reduced pressure condition, typically at a pressure of about 20 kPa or less. Often, the unprepared fish fillet is subjected to pressure of about 20 kPa or less for about 3 hours or less per gram of the unprepared fish fillet.

### BRIEF DESCRIPTION OF THE DRAWINGS

FIG. 1 is a bar graph showing the percent mercury removal in fish tissue at various pH levels. In particular, the 0.1 M HCl, 0.01 M HCl, no HCl, 0.01 M NaOH, and 0.1 M NaOH are pH 1, pH 2, pH 7, pH 12 and pH 13, respectively.

FIG. 2 is a bar graph showing comparative results of percent mercury loss in fish tissue at various pH and vacuum tumbling time. The pH of 0.05 M HCl, 0.1M HCl, 0.5 M HCl and 1.0 M HCl are pH 1.3, pH 1.0, pH 0.3, and pH 0, respectively.

FIG. 3 is a bar graph showing the percent mercury removal at various salt concentrations.

FIG. 4 is a bar graph showing the percent mercury removal using different mercury chelating agent.

FIG. 5 is a bar graph showing the percent mercury removal using different mercury chelating agent in HCl solution.

FIG. 6 is a bar graph showing the percent mercury removal using oxalic acid solutions at various vacuum tumbling times.

FIG. 7 is a bar graph showing the percent mercury removal using citric acid, oxalic acid and veggie prep solutions.

FIG. 8 is a bar graph showing the percent mercury removal using a solution containing citric acid and 2 grams of methylsulfonyl methane (MSM).

FIG. 9 is a bar graph showing comparative results of the percent mercury removal using 10 g oxalic acid solution with and without 2 g of MSM.

FIG. 10 is a bar graph showing comparative results of the amount of mercury removed at various oxalic acid concentrations in the presence of 2 g of MSM.

FIG. 11 is a bar graph of comparative results of the amount of mercury removal between fish fillet of 1 cm thickness and 1 cm cubes.

FIG. 12 is a bar graph showing comparative results of mercury removal at various fish fillet thickness.

FIG. 13 is a bar graph showing comparative results of mercury removal between citric acid and oxalic acid solutions.

FIG. 14 is a bar graph showing comparative results of mercury removal in the presence of different mercury chelating agent or in the absence of any chelating agent.

### DETAILED DESCRIPTION OF THE INVENTION

Some aspects of the invention provide food processing compositions and methods for using the same to remove mercury pollutant (e.g., methyl mercury) in unprepared (i.e., uncooked) food articles, such as fish tissues (fillets). As used herein, the term “remove” when used in reference to mercury pollutant refers to eliminating or reducing the amount of mercury pollutant that is present in the unprepared food article. The term “unprepared food article” refers to uncooked and un-marinated food article. By removing toxic mercury from the unprepared food articles, methods and compositions provide safer, healthier food articles for commercial and home use.

While compositions and methods of the invention are applicable in removing mercury from any type of food articles, e.g., fish, meat, vegetables, fruit, etc., for the sake of brevity and clarity, the present invention will now be described in reference to removing mercury from fish, in particular from fish fillet. It should be appreciated that compositions of the invention are also referred herein as “mercury removal solution” and “mercury removal marinade” as well as other terms, which can be readily determined by the context of their usage within this disclosure.

In some particular embodiments, compositions of the invention comprise an aqueous solution that includes a consumable acid and a mercury chelating agent. Such aqueous solution is typically hypotonic, i.e., the salinity of the aqueous solution is lower than the salinity level of the cells of the food article to be treated. Typically, salinity of the aqueous solution is from about 25% to about 75% of the food article salinity. Since the salinity of salt water fish (e.g., sword fish, salmon, tuna, mackerel, etc.) is significantly different from the salinity of fresh water fish (e.g., walleyes, small mouth bass, large mouth bass, trout, perch, etc.), salinity of the aqueous solution can vary depending on the food article to be treated. However, it should be appreciated that salinity of the aqueous solution is not limited to the ranges disclosed herein. Accordingly, the scope of the invention include all salinity level as long as the osmotic pressure of the aqueous solution is lower than the osmotic pressure in cells of food article to be treated.

The present inventors have discovered that the rate and the amount of mercury removal in fish fillet are dependent on a variety of factors including, but not limited to, salt concentrations, type and/or the amount of consumable acid used, type and/or the amount of the consumable mercury chelating agent used, the pressure of treatment, etc. In particular, it was discovered that more efficient mercury extraction was achieved when the aqueous solution is hypotonic relative to the fish fillet cells. It was also discovered that as aqueous solution's ionic strength became hypertonic, mercury extraction yields become lower. Therefore, in general the aqueous solution's electrolyte or osmotic pressure used is less than the osmotic pressure of cytosol within the fish tissue cells. Typically, salt, sugar, a consumable organic acid, a consumable mercury chelating agent, or a combination thereof is used in preparing a hypotonic aqueous solution. Exemplary salts that can be used in a hypotonic aqueous solution for mercury extraction include, but are not limited to, NaCl, KCl, MgCl₂, CaCl₂, etc. Exemplary sugars that can be used in a hypotonic aqueous solution include, but are not limited to, glucose, sucrose, fructose, galactose, mannose, etc. Exemplary consumable organic acids that can be used in a hypotonic aqueous solution include, but are not limited to, citric acid, oxalic acid, ascorbic acid, acetic acid, tartaric acid, phosphoric acid, etc. Exemplary consumable mercury chelating agents that can be used in a hypotonic aqueous solution include, but are not limited to, cysteine, acetyl cysteine, methionine, acetyl methionine, methyl sulfonylmethane, taurine, thiosulfate, etc.

The rate and efficiency of mercury removal in fish fillet is also dependent on the pH of the aqueous solution. The studies of pH using a strong acid such as hydrochloric acid or a strong base such as sodium hydroxide resulted in the highest mercury extraction percentages from the fish tissues occurring at a pH of 1.0 and 13.0. Percent mercury loss of over 60% was achieved at pH 1 and pH 13 with a vacuum tumbling time of 4 hours. Since cell lysis can occur in basic solutions, typically pH of the aqueous solution is about pH 7 or less.

Methods of the invention include extracting mercury from fish fillet typically at pH ranging from pH 1 to pH 7. The pH of aqueous solution was adjusted using a consumable acid. As used herein, the term “consumable acid” refers to an acid that can be consumed by mammal, typically human, at a concentration used in compositions of the invention without any significant toxic or ill effect. In some embodiments, the consumable acid is an organic acid. Suitable organic acids include consumable mono- and di-carboxylic acids. Exemplary consumable organic acids include, but are not limited to, acetic acid, oxalic acid, maleic acid, glutamic acid, citric acid, ascorbic acid, formic acid, lactic acid, and tartaric acid. In other embodiments, the consumable acid is an inorganic acid such as, but not limited to, phosphoric acid. In other embodiments, a mixture of acids is used. Typically, however, acids that are used in compositions and methods of the invention are those that naturally occur in fruits and vegetables.

It was discovered by the present inventors that solutions that were 1% in citric acid extracted 50% of the mercury from carp tissue while solutions that were 1% in oxalic acid extracted 70% of the mercury from carp tissue over 4 hours. It was also discovered that a 0.5% solution of oxalic acid extracted 40% of the mercury from the carp tissue over 4 hours, but when 0.1% methylsulfonylmethane was added to the 0.5% oxalic acid solution the mercury extraction increased to 80%. In another experiment, it was discovered that a 0.5% solution of citric acid with 0.1% acetyl cysteine extracted 60% of the mercury from carp tissue over 4 hours.

These results show that the mercury extraction can be significantly improved with the use of a consumable mercury chelating agent such as a compound comprising a thiol, a sulfone and/or sulfonic acid functional groups. As used herein, the term “consumable mercury chelating agent” refers to a consumable compound or a composition comprising a functional group that coordinates with and removes mercury ions and/or methyl mercury from the food article. In some embodiments, the consumable mercury chelating agent is a compound or a composition comprising a sulfur functional group, such as a sulfone, thiol, sulfonic acid, etc. Exemplary consumable mercury chelating agents include, but are not limited to, methylsulfonylmethane, acetyl cysteine, taurine, cysteine, acetyl methionine, methionine, lipoic acid, meso 2,3-dimercaptocuccinic acid, dimavaldimercapto propane sulfonate, thiosulfate, etc.

In other embodiments, the consumable mercury chelating agent comprises or is derived from a food source. Exemplary food sources that can be used as a consumable mercury chelating agent include, but are not limited to, garlic, onion, nuts, seeds, watermelon, cilantro, broccoli, cabbages, spinach, pineapple, papaya, coconut, mustard, watercress, asparagus, parsley. It should be appreciated that the consumable mercury chelating agent can be derived from one or more food sources.

The present inventors have also discovered that in some embodiments, a combination of a consumable organic acid [e.g., ranging from 0.1% to 1% (w/w)] with a consumable mercury chelating agent [ranging from 0.01% to 0.5% (w/w)] that have a functional group such as thiol, sulfone, and/or sulfonic acid resulted in mercury extraction of at least 80% after 2 hours of vacuum tumbling. The use of consumable mercury chelating agent allows for lower organic acid concentrations in the extraction process. As expected, using a relatively low concentration of consumable organic acid results in a relatively higher pH of the solution. In some instances, a relatively higher pH (e.g., pH 2 to pH 4) is desirable in the mercury extraction process, for example, to minimize visual changes in the fish tissue.

In some embodiments, aqueous solutions of the invention have pH of about 7. In one particular embodiment, such a solution comprises baking soda and acetyl cysteine.

Other embodiments of the invention provide the aqueous solution for removing mercury from fish fillet comprising common cooking ingredients. Exemplary common cooking ingredients include, but are not limited to, garlic, citric acid, vinegar (i.e., acetic acid), oxalic acid, methylsulfonylmethane, acetyl cysteine, taurine, etc. In some instances, solutions comprising common cooking ingredients were used to obtain 70-90% mercury removal (i.e., extraction). Exemplary solutions comprising common cooking ingredients include solutions that use citric acid and/or oxalic acid, which are commonly used in food ingredients, as consumable acids. Solutions that use common cooking ingredients also include solutions that use methylsulfonylmethane, acetyl cysteine, and/or taurine, which are natural ingredients that are currently sold as nutritional supplements, as mercury chelating agents.

Some methods of the invention include contacting a fish fillet with the aqueous solution of the invention under standard temperature and pressure. While a variety of factors influence the amount of mercury removal (e.g., the type of acid and/or mercury chelating agent used, the salinity level of the solution, the amount of time fish fillet is placed in the solution, etc.), typically methods of the invention removes at least 25%, typically at least 50%, and often at least 70% of mercury. Alternatively, methods of the invention provide purified fish fillets having no more than 0.5 ppm, typically no more than 0.2 ppm, and often no more than 0.1 ppm of mercury per gram of fish fillet.

In some methods of the invention, a fish fillet is placed in (or contacted with) a solution described herein and subjected to a vacuum. In some embodiments, the fish fillet in the mercury removal solution is placed in a vacuum tumbler, such as Marinade Express available from Creative Culinary Solutions, Inc. (Harland, Wis.). However, it should be appreciated that the combination or admixture of a fish fillet and the mercury removal solution need not be subjected to vacuum. The combination can simply be left standing at a temperature and time sufficient to remove the desired amount of mercury from the fish fillet.

Regardless of whether a vacuum tumbler is used or not, typically the temperature at which the fish fillet is placed in the mercury removal solution is room temperature or less, often about 20° C. or less, and more often 10° C. or less.

The length of time for removing a sufficient amount of mercury from a fish fillet depends on a variety of factors, such as the temperature, the type of acid used, pH of the solution, the type of mercury chelating agent used, etc. In general, when a vacuum tumbler is used, the length of time the fish fillet is placed in the mercury removal solution or marinade is about 0.5 h or more, typically about 1 h or more, and often 2 h or more at 10−20 kPa of pressure for 100-1000 g of fish fillet. When a vacuum tumbler is not used, the length of time the fish fillet is placed in the mercury removal solution or marinade is about 1 h or more, typically about 2 h or more, and often 4 h or more for 100-1000 g of fish fillet. Alternatively in some embodiments, only vacuum is used without any tumbling of the mixture. In such embodiments, the length of time the fish fillet is placed in the mercury removal solution or marinade is about 2 h or more, typically about 4 h or more, and often 12 h or more at 10−20 kPa of pressure for 100-1000 g of fish fillet.

In one particular embodiment, methods of the invention provide using vacuum tumbles in combination with the aqueous solution disclosed herein to remove methyl mercury from fish fillets. Such methods provide safer, healthier fish fillets for commercial and home use.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

The following tables show the percentage of mercury extraction in carp and walleye fillets using a vacuum tumbler at 15 kPa in various hypotonic aqueous solutions. It should be noted that in a taste test using various acids, citric acid was found to have the best taste.

Carp (1 Cubic Centimeter Dimension. Volume of Solution was 1.9 μl

| | Tumble Time (min) | | | |
|---|---|---|---|---|
| | 30 | 60 | 120 | 240 |
| 10 g oxalic acid | 16 | 23 | 35 | 43 |
| 25 g oxalic acid | 55 | 63 | 62 | 71 |
| 25 g citric acid | 32 | 36 | 51 | 51 |
| Veggie prep | 34 | 44 | 45 | 47 |
| 10 g oxalic acid + 2 g MSM | 46 | 51 | 54 | 69 |
| 10 g citric acid + 2 g MSM | 36 | 44 | 44 | |
| 10 g oxalic acid + 2 g acetyl cysteine | 48 | 50 | 50 | |
| 10 g citric acid + 2 g acetyl cysteine | 43 | 50 | 62 | 61 |
| 25 g oxalic acid + 2 g MSM | 44 | 53 | 61 | 68 |

Walleye (1 Cm Thick Fillets)

| | Tumble Time (min) | | |
|---|---|---|---|
| | 30 | 60 | 120 |
| 10 g oxalic acid | 26 | 32 | 66 |
| 25 g oxalic acid | 30 | 45 | 60 |
| 10 g oxalic acid + 2 g MSM | 38 | 40 | 79 |
| 10 g oxalic acid + 2 g acetyl cysteine | 32 | 35 | 42 |
| 10 g citric acid + 2 g MSM | 19 | 30 | 39 |
| 10 g citric acid + 2 g acetyl cysteine | 19 | 35 | 40 |

As shown in the table above, some of the notable mercury extractions for various conditions include: (i) 50% mercury extraction (90 minutes for 1 cubic centimeter) using 25 g citric acid; (ii) 45% mercury extraction (60 minutes for 1 cubic centimeter) using 10 g citric acid and 2 g MSM; (iii) 60% mercury extraction (90 minutes for 1 cubic centimeter) using 10 g citric acid and 2 g acetyl cysteine; (iv) 70% mercury extraction (240 minutes for 1 cubic centimeter) using 25 g oxalic acid; (v) 70% mercury extraction (240 minutes for 1 cubic centimeter) using 10 g oxalic acid and 2 g MSM; and (vi) 50% mercury extraction (240 minutes for 1 cubic centimeter) using 10 g oxalic acid and 2 g acetyl cysteine. It should be noted, however, that the amount of mercury extraction can vary depending on a various factors such as, but not limited to, the tumble time and the size of fish fillet. For example, in general the tumble time of 60 minutes for one cm thick fish fillet resulted in about 30-40% mercury extraction.

As can be seen in the above tables, use of 10 g oxalic acid and 2 g MSM resulted in mercury extractions as high as about 80%. The taste test resulted in the taste of oxalic acid being observed in the fish fillets. This taste may be used as flavoring with other ingredients to make a spicy marinade for fish with high mercury extractions.

Salt test were also conducted which indicated up to 5 grams of salt (NaCl) can be added to the solutions without significantly changing mercury extraction rates and efficiencies.

Some of the conditions that were found to be useful in mercury extraction include, but are not limited to, the following conditions: (i)15 g of citric acid, 3 g of acetyl cysteine, and 5 g of salt in 1.9 L of water. Using this aqueous solution, typically about 20 to 40% of mercury can be extracted at 30 minutes of vacuum tumbling, about 30 to 50% of mercury can be extracted at 60 minutes of vacuum tumbling, and about 35 to 60% of mercury can be extracted at 90 minutes of vacuum tumbling; and (ii) 15 g of oxalic acid, 3 g of MSM, 5 g of salt plus other spices in 1.9 L of water. Using this aqueous solution, typically about 35 to 50% of mercury can be extracted at 30 minutes of vacuum tumbling, about 40 to 50% of mercury can be extracted at 60 minutes of vacuum tumbling, and about 50 to 80% of mercury can be extracted at 90 minutes of vacuum tumbling.

The studies of pH using a the strong acid of hydrochloric or strong base of sodium hydroxide resulted in the highest mercury extraction percentages from the fish tissues occurring at a pH of 1.0 and 13.0. Percent mercury loss of over 60% was achieved at a pH of 1 and 13 with a vacuum tumbling time of 4 hours. The tissue processed at pH 13 however was not suitable for cooking processes.

Studies of salt concentrations showed mercury extractions were more effective when the solution was hypotonic. As marinade solutions ionic strength became hypertonic, mercury extraction yields became lower. Therefore, other studies were carried out using solutions in which the solutions electrolyte or osmotic pressure was less than that of the cell's cytosol within the fish tissue.

Studies using oil in the extraction process resulted in no noticeable increases in mercury extractions.

Typically, mercury extractions from fish tissue were highest at pH's between 1 to 7 and under hypotonic solution conditions. Therefore, organic acids and natural mercury binding ligands with functional groups containing thiol, sulfones, and/or sulfonic acid groups were used in various studies. Some of the organic acids studied include citric acid and oxalic acid both of which occur naturally in fruits and vegetables. Solutions that were 1% in citric acid extracted 50% of the mercury from carp tissue while solutions that were 1% in oxalic acid extracted 70% of the mercury from carp tissue over 4 hours. A 0.5% solution of oxalic acid extracted 40% of the mercury from the carp tissue over 4 hours but when 0.1% methylsulfonylmethane was added to the 0.5% oxalic acid solution the mercury extraction increased to 80%. This illustrates that the mercury extraction or removal is improved with the use of a sulfone ligand. Similar improvements in mercury extractions were observed using acetyl cysteine and taurine as mercury binding ligands. These are examples of using ligands that contain thiols and sulfonic acid groups to enhance mercury extractions from fish tissue. The combination of organic acids from 0.1% to 1% (w/w) with ligands at 0.01% to 0.5% (w/w) that have functional groups of thiols, sulfones, and/or sulfonic acids groups resulted mercury extractions at 80% after 2 hours of vacuum tumbling. It should be appreciated that the % by weight refers to the amount relative to the amount of water used in making the aqueous solution. For example, 1% by weight (or w/w) of organic acid means 1 g of organic acid is added to 100 g of water.

The use of mercury binding ligands (i.e., mercury chelating or removing agent) allowed for lower organic acid concentrations in the extraction process which results in the pH of the solutions to increase. In some instances, a higher pH of 2-4 is desirable in the mercury extraction process to minimize visual changes and taste changes in the fish tissue. The pH can be adjusted to pH of 7 while allowing reduction in the mercury levels in the fish tissue by using a combination of baking soda and acetyl cysteine.

In some embodiments, common cooking ingredients are used to achieve at 70-90% reduction in mercury from a fish fillet. For example, citric acid and oxalic acid are commonly used as food ingredients. In addition, methylsulfonylmethane, acetyl cysteine, and taurine are all natural ingredients that are currently sold as nutritional supplements. By using these ingredients, the present inventors were able to reduce the mercury level in a fish fillet by at least 70%, typically in the range of 70-90%.

The taste test indicated the use of citric acid resulted in a better taste compared to using oxalic acid. About 60% of mercury can be removed from a fish fillet using 10 g of citric acid and 2 g of acetyl cysteine. It should be appreciated, however, that the actual amount of mercury removal dependents on other factors including, but not limited to, the tumble time, vacuum pressure, and the size of fish fillet. For example, tumble time of 60 minutes and fish fillets of one centimeter in thickness typically results in 30-40% mercury extraction.

A mixture containing 10 g of oxalic acid and 2 g of MSM in 1.9 L of water resulted in mercury extractions as high as 80%. The taste test resulted in the taste of oxalic acid being observed in the fish fillets. This taste may be used as flavoring with other ingredients to make a spicy marinade for fish with high mercury extractions.

The following composition can be used to remove 40-50% and up to 80% mercury from fish fillets. A mixture of 15 grams citric acid, 3 g AC, and 5 grams salt in 1.9 L of water typically resulted in 30 to 40% mercury extractions at 30 minutes of vacuum tumbling, 40 to 50% mercury extractions at 60 minutes of vacuum tumbling, and 50 to 60% mercury extraction at 90 minutes of vacuum tumbling. A mixture containing 15 g oxalic acid, 3 g MSM, 5 grams salt plus other spices in 1.9 L of water typically resulted in 40 to 50% mercury extractions at 30 minutes of vacuum tumbling, and 50 to 80% mercury extraction at 90 minutes of vacuum tumbling.

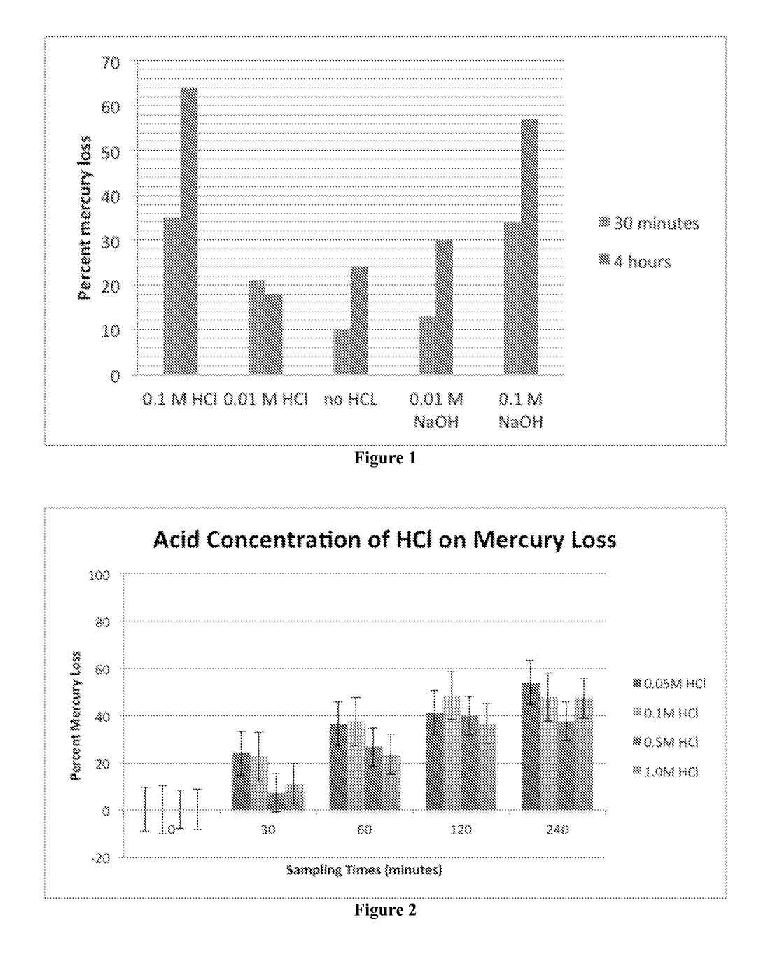

Results of some of various experiments are shown in FIGS. 1-14. In particular, FIG. 1 shows percent mercury removal at various pH in fish tissues that have been cut into 1 cm³ cm piece. As can be seen, the highest mercury removal occurred at a pH of 1 and 13. Percent mercury loss of over 60% was achieved at a pH of 1 with a vacuum tumbling time of 4 hours.

FIG. 2 shows the results of percent mercury removal at various acidic pH levels at different vacuum tumbling times. Fish tissues were cut into 1 cm³ pieces and subjected to the pH and vacuum tumbling times as indicated. As the results show, the highest mercury extraction was achieved at HCl concentrations between 0.05 M and 0.1M. And as FIG. 2 shows, almost 60% mercury removal was achieved at pH's between 1.3-1.0 with a vacuum tumbling time of 4 hours.

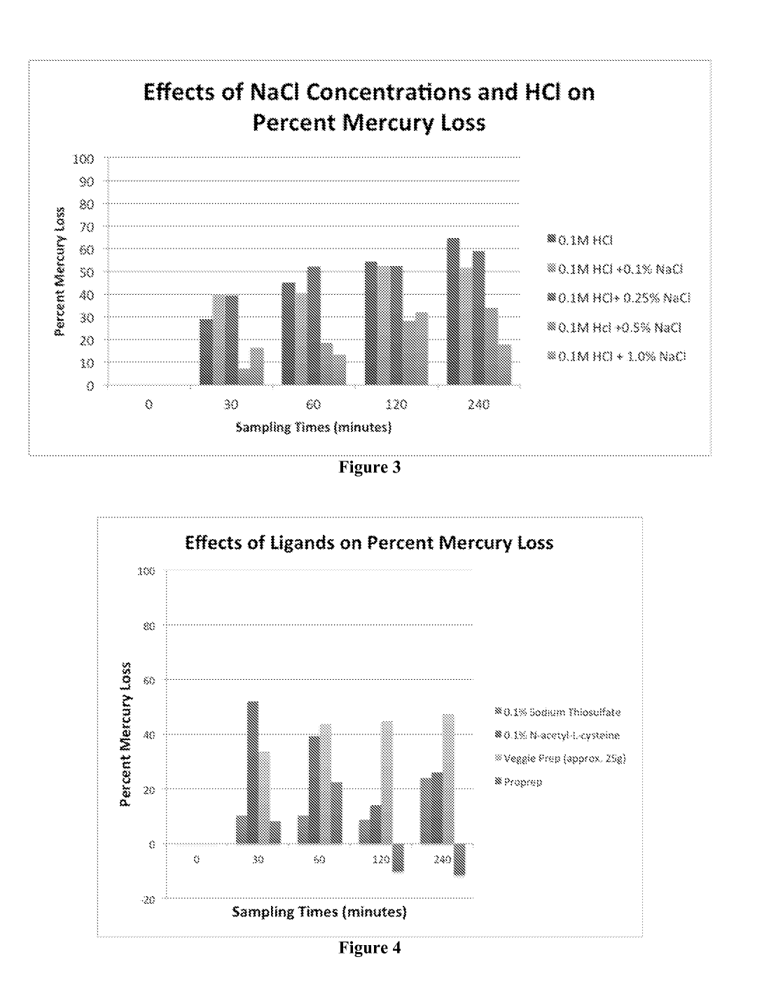

FIG. 3 shows the results of percent mercury removal at various salt concentrations. Fish tissues were cut into 1 cm³ pieces and placed in a various salt concentration solutions and subjected to vacuum tumbling for 4 hours. All of the solution had pH of 1. The highest mercury removal occurred from the fish tissues with no salt to 0.25% NaCl salt added to the mixture. Salt mixture of greater than 0.25% NaCl resulted in a lower amount of mercury removal compared to no salt solution. As can be seen in FIG. 3, mercury removal of over 60% was achieved at a pH of 1.0.

FIG. 4 shows the result of percent mercury removal using various mercury chelating agents. Fish tissue were cut into 1 cm³ pieces and placed in various solutions containing different mercury chelating agents. As can be seen, the veggie prep (sold by Creative Culinary Solutions (Harland, Wis.) which comprises about 25 g citric acid and 5 grams salt) and N-acetyl-L-cysteine gave results of about 50% mercury extraction. It should be noted that these solutions were without any addition of HCl or organic acids. However, the veggie prep has citric acid as a main ingredient; accordingly, the veggie prep solution is acidic.

FIG. 5 shows the results of percent mercury removal using various mercury chelating agent in the presence of HCl. Fish tissues were cut into 1 cm³ pieces and placed in solutions containing different mercury chelating agents and 0.1 M of HCl. As can be seen, by increasing the acid concentration along with the use of mercury chelating agent, the amount of mercury removal was increased up to 70% within an hour of vacuum tumbling.

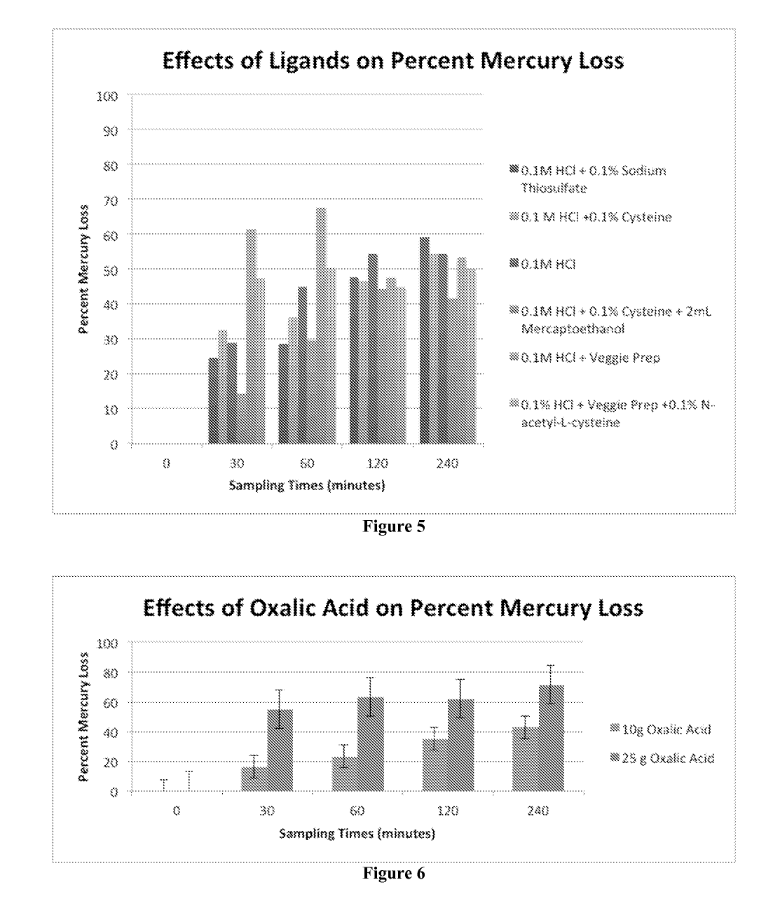

FIG. 6 shows the results of percent mercury removal using oxalic acid solutions. Fish tissue were cut into 1 cm³ pieces and placed in a solution comprising different amount of oxalic acid. In particular, solutions of 0.06 M (10 grams) and 0.12 M (25 grams) oxalic acid were used to remove mercury. As can be seen the 0.12 M oxalic acid solution resulted in higher mercury removal, e.g., up to 70% under vacuum tumbling.

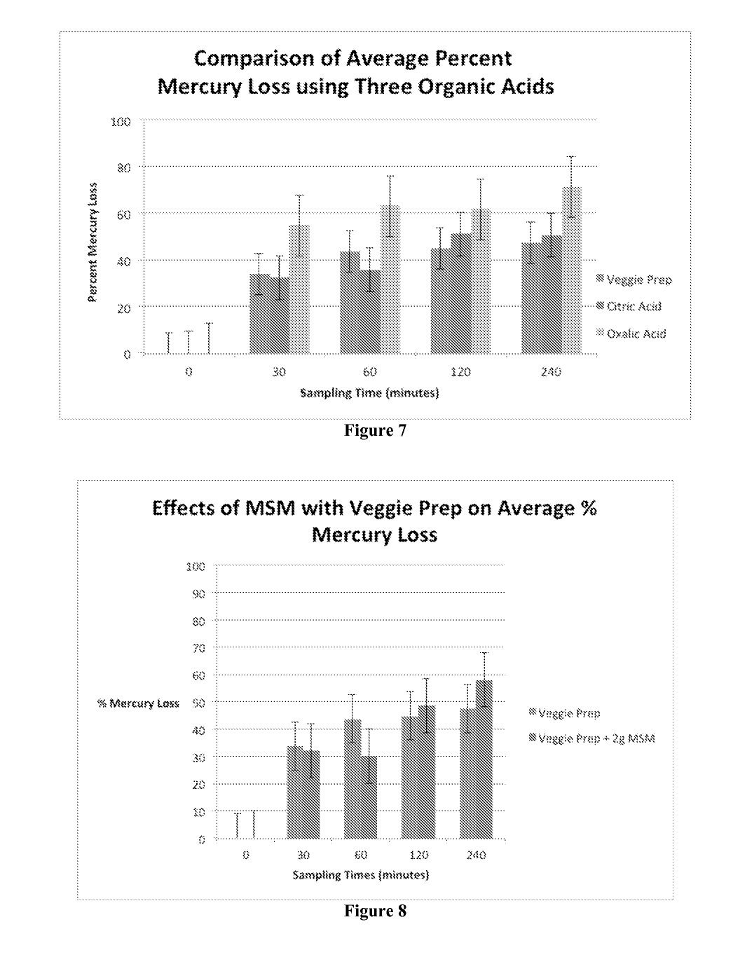

FIG. 7 shows the comparative results of percent mercury removal using citric acid, oxalic acid and veggie prep solutions. The organic acids of citric acid and oxalic acid were tested to extract mercury from the fish tissue as disclosed above. Each solution had 25 grams of organic acid or veggie prep added to the solution. As can be seen, solutions containing citric acid and veggie prep resulted in mercury removal of about 50%. The similar results of citric acid and veggie prep were expected since veggie prep contains citric acid. Oxalic acid resulted in a higher mercury removal of over 70%.

FIG. 8 shows the comparative results of percent mercury removal in the presence and in the absence of methylsulfonyl methane (MSM). Fish tissues (1 cm³ pieces) were placed in a solution comprising veggie prep (which includes citric acid) and 2 g of MSM. The mixture was vacuum tumbled and the amount of mercury loss was determined at various times. Each solution had one package of veggie prep added to the solution and one solution also had the addition of 2 grams of MSM. As can be seen, the veggie prep solution resulted in mercury removal of about 40-50%. The veggie prep plus MSM solution resulted in mercury removal of 50-60% indicating that the use of a mercury chelating agent provides higher amount of mercury removal.

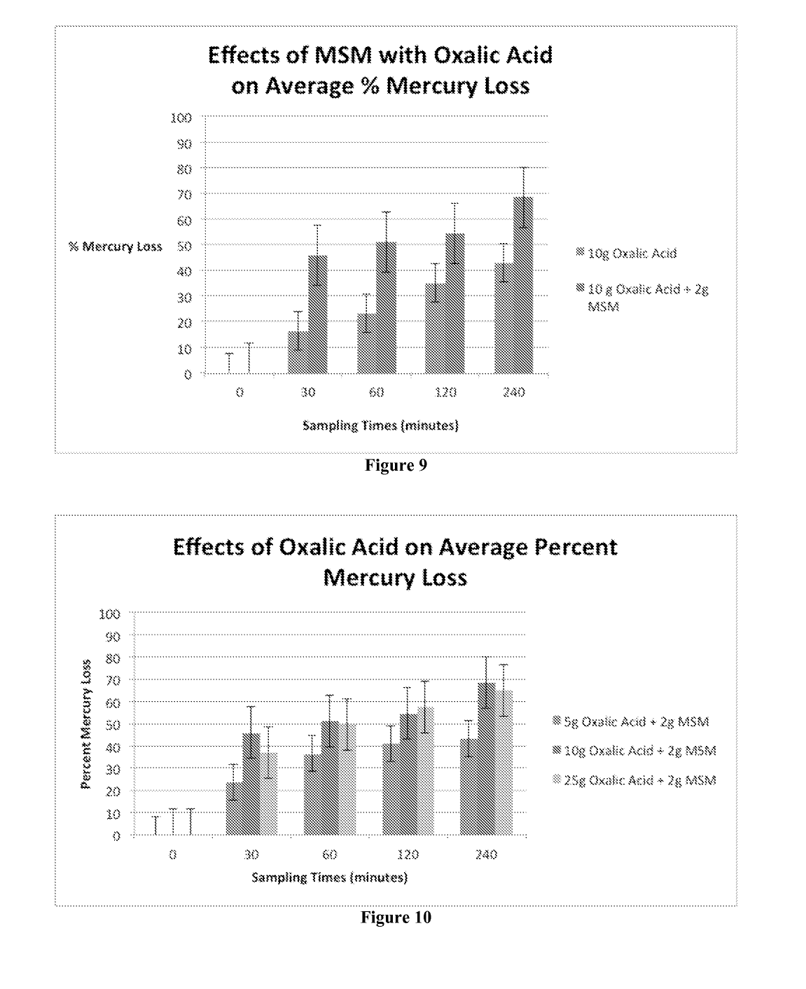

FIG. 9 shows the comparative results of percent mercury removal using a solution comprising oxalic acid and methylsulfonyl methane (MSM). Fish tissues were cut into 1 cm³ pieces and placed in different solutions. Each solution had 10 grams of oxalic acid added to the solution and one solution also had the addition of 2 grams of MSM. As can be seen, the oxalic acid solution in the absence of MSM resulted in mercury removal of about 40-50%. The oxalic acid solution having MSM resulted in a higher mercury removal, i.e., 60-70%.

FIG. 10 shows the comparative results of percent mercury removal at various oxalic acid amounts with 2 grams of methylsulfonyl methane (MSM). Fish tissues were cut into 1 cm³ pieces and placed in different oxalic acid concentration solutions, i.e., 0.03 M (5 grams), 0.06M (10 grams), or 0.12 M (25 grams) of oxalic acid and 2 grams of MSM. The resulting mixture was vacuum tumbled for times shown in FIG. 10, and the amount of mercury extraction from the fish tissue was measured. As can be seen, the oxalic acid solution of 0.06 M plus 2 grams MSM resulted in the highest mercury extraction 60-70%.

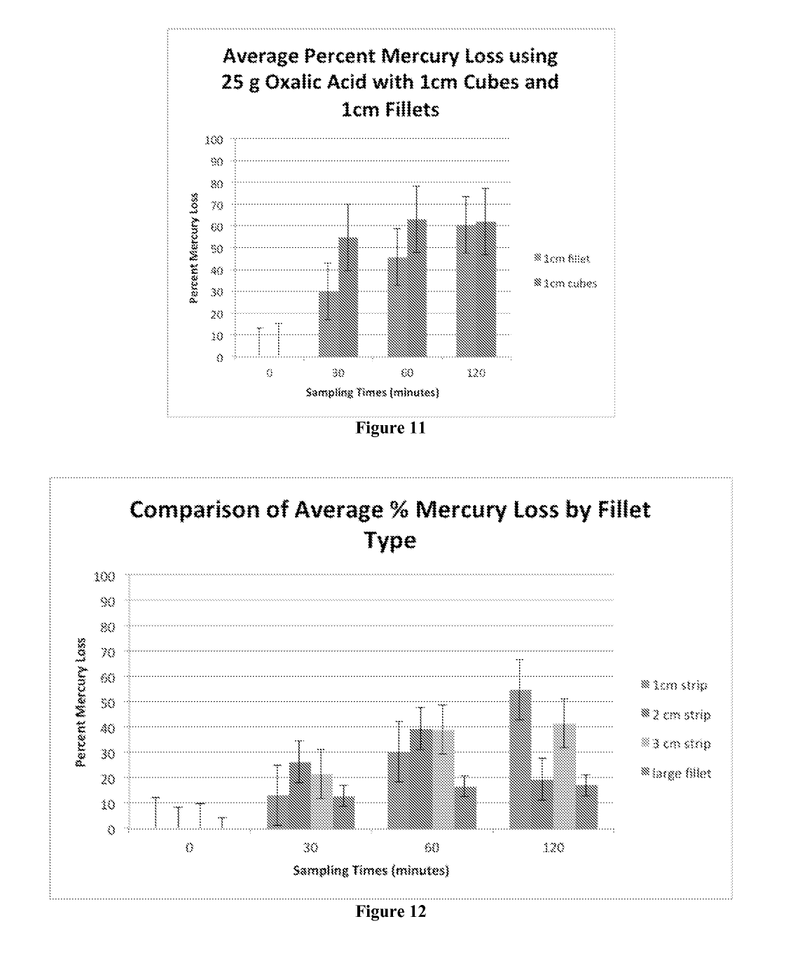

FIG. 11 shows comparative results of the amount of mercury removal between fish fillet strip of 1 cm thickness and 1 cm cubes. Each fish tissue was placed in a solution comprising 0.12M (25 grams) of oxalic acid and subjected to vacuum tumbling, and the amount of mercury removed was measured at various times. As can be seen, for 1 cm cubes a higher amount of mercury removal was observed at 30 and 60 minutes. However, a mercury removal of about 60% was achieved after two hours of vacuum tumbling for both dimensions of fish fillets.

FIG. 12 shows comparative results of the amount of mercury removal at various thickness of fish fillets. In particular, fish fillet strip of 1, 2, 3, or full fillet strips were placed in 0.03M (5 grams) of oxalic acid solution comprising 5 grams of MSM and vacuum tumbled. As can be seen, in general 1 cm thick fish fillet showed highest amount of mercury removal. At 2 hours, mercury removal of 50-60% was achieved for the 1 cm strip of fish fillet.

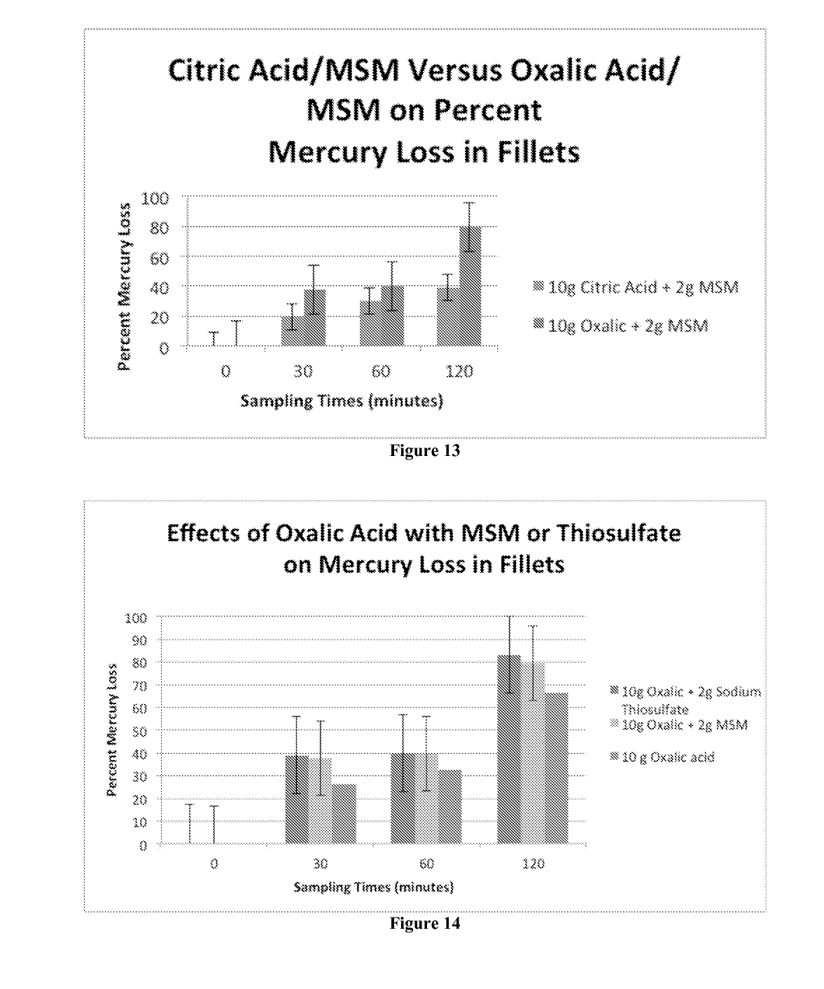

FIG. 13 shows comparative results of the amount of mercury removed in 1 cm thick fish fillets in citric acid and oxalic acid solutions. Fish fillet strips of 1 cm thickness was placed in either a 0.06M (10 grams) solution of oxalic acid plus 2 grams MSM or a 0.01 M solution of citric acid (10 grams) plus 2 grams MSM. The resulting mixture was vacuum tumbled and the amount of mercury loss was measured. As can be seen, the solution comprising citric acid and MSM resulted in mercury extractions of about 40% at 2 hours. But a solution comprising oxalic acid plus MSM solutions in a significantly better mercury removal of more than 80% after 2 hours.

FIG. 14 shows comparative results of the amount of mercury loss in 1 cm thick fish fillets between a solution comprising thiosulfate and a solution comprising MSM. Fish fillet strips of 1 cm thickness was placed in a solution of 0.06M (10 grams) oxalic acid, 0.06M oxalic acid plus 2 grams sodium thiosulfate, or 0.06M oxalic acid plus 2 g of MSM and vacuum tumbled and the amount of mercury loss was measured at various time. As can be seen, the solution comprising thiosulfate or MSM resulted in a similar mercury removal of about 80% at 2 hours. In general, the addition of a mercury chelating agent (e.g., thiosulfate or MSM) increased the mercury removal by 10-20%.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An aqueous solution adapted for removing mercury from a food article, said solution comprising a consumable acid, a consumable mercury chelating agent, and sodium chloride concentration of from about 0.15% by weight to about 1% by weight.

2. The aqueous solution of claim 1, wherein said consumable acid comprises an organic acid.

3. The aqueous solution of claim 2, wherein said organic acid is selected from the group consisting of oxalic acid, malic acid, citric acid, acetic acid, glutamic acid, ascorbic acid, formic acid, lactic acid, and a combination thereof.

4. The aqueous solution of claim 1, wherein said consumable mercury chelating agent comprises acetyl cysteine, taurine, methylsulfonylmethane (MSM), methionine, acetyl methionine, thiosulfate, or a combination thereof.

5. The aqueous solution of claim 1, wherein said consumable mercury chelating agent is derived from a food source.

6. The aqueous solution of claim 5, wherein said food source comprises garlic, onion, nuts, seeds, watermelon, cilantro, broccoli, cabbages, spinach, pineapple, papaya, coconut, mustard, watercress, asparagus, parsley, or a combination thereof.

7. The aqueous solution of claim 1, wherein the sodium chloride concentration ranges from about 0.15% by weight to about 0.5% by weight.

8. The aqueous solution of claim 1, wherein the sodium chloride concentration ranges from about 0.25% by weight to about 1.0% by weight.

9. The aqueous solution of claim 1, wherein the pH of said aqueous solution ranges from about pH 1 to about pH 7.

10. The aqueous solution of claim 1, wherein the concentration of said consumable mercury chelating agent ranges from about 0.005% by weight to about 0.5% by weight.

11. A method for removing mercury from an unprepared food article comprising:
a) contacting an unprepared food article with an aqueous solution of claim 1 under conditions sufficient to remove at least 20% of mercury from the unprepared food article to produce a purified food article having a reduced amount of mercury; and
b) separating the purified food article.

12. The method of claim 11, wherein said step of contacting the unprepared food article with the aqueous solution of claim 1 further comprises subjecting a resulting mixture to a reduced pressure condition.

13. The method of claim 12, wherein the resulting mixture is subjected to a pressure condition of about 20 kPa or less

14. The method of claim 13, wherein the unprepared food article is fish.

15. A method for reducing the amount of mercury from a mercury contaminated food article comprising:
a) contacting a mercury contaminated food article with an aqueous solution comprising a consumable acid and a consumable mercury chelating agent under conditions sufficient to provide a purified food article having about 1 ppm of mercury or less per gram of the purified food article, wherein the osmotic pressure of said aqueous solution is less than that of the cytosol osmotic pressure of cells of said food article; and
b) separating the purified food article.

16. The method of claim 15, wherein the mercury contaminated food article is a fish.

17. The method of claim 16, wherein the sodium chloride concentration of said aqueous solution ranges about 25% to about 75% of the salinity of the fish.

18. The method of claim 17, wherein said step of contacting the mercury contaminated food article with said aqueous solution comprises subjecting a resulting mixture to a reduced pressure condition.

19. The method of claim 18, wherein the resulting mixture is subjected to a pressure condition of about 20 kPa or less.
